(19) United States
(12) Patent Application Publication
(10) Pub. No.: US 2005/0031820 A1
(43) Pub. Date: Feb. 10, 2005

(54) Information-bearing pavement tape

(76) Inventor: Gregory Winfield Gorman, Golden, CO (US)

Correspondence Address: LATHROP & GAGE LC, 4845 PEARL EAST CIRCLE, SUITE 300, BOULDER, CO, 80301, US

(21) Appl. No.: 10/633,943

(22) Filed: Aug. 4, 2003

(51) Int. Cl. B32B 9/00

(52) U.S. Cl. 428/40.1; 156/71; 428/137

(57) ABSTRACT

A pavement tape for conveying commercial information when affixed to pavement, said pavement tape comprising an elongated flexible tape body comprising front and rear faces, said front face bearing at least one symbol that conveys commercial information and said rear face comprising an adhesive for bonding said pavement tape to pavement.

### BACKGROUND

1. Field

This application relates to the field of dissemination of information on roads, parking lots, and walkways. More particularly, this application relates to pavement tapes that are marked in a manner that conveys information of various kinds to the motorist or pedestrian.

2. Discussion of Related Art

Communication is important to modem societies. In many respects, it defines the form of a society. The earliest communications required a real-time exchange between the sender and receiver. Later, with the development of writing, the sender and receiver no longer had to be in direct contact. The forms of communication that developed after that—including telegraph, telephone, radio, television, communications satellites, cellular telephones and the Internet, to name a few—have enabled rapid, high-volume communication worldwide.

Signage is one traditional form of communication. Before the automobile, the viewers of signage traveled limited distances in a given day. Road signs were few. They related to roads well traveled and well known. Advertisements were directed primarily towards goods and services for purchase at familiar neighborhood shops.

With the advent of the automobile, people could travel far greater distances at far higher speeds. Motorists easily moved into unknown territory and needed coherent directions. They needed signs to define stopping points, lane delineations, turning points, crosswalk barriers and other road characteristics. Pedestrians needed signs to avoid encounters with automobiles, among other things.

Tourism grew and with it a tourist industry seeking to obtain the patronage of the increasingly mobile public. Billboards, street signs, and pavement markings became familiar and trusted resources for motorized and pedestrian traffic alike. Today, safe and enjoyable motorized and pedestrian travel is heavily dependent upon well-designed outdoor and indoor signage.

Pavement marking was an early method for directing motor and foot traffic. In the era of brick roads, different colored bricks were used to convey safety information. Later, paint was used. Early paints had poor durability under the demanding conditions of foot and motorized traffic and the environment. In addition, pavement painting was usually a time consuming and disruptive task. Paint needed time to dry and traffic had to be kept off the painted surface until drying was complete. Rain, cold and heat adversely affected the drying time and the success of the operation. Once paint was dry and in use, it often was difficult to remove when changes in the traffic pattern were required.

Pavement marking tapes also have been used for pavement marking. Pavement marking tapes could be applied more quickly than paint, reducing traffic disruptions. Early pavement marking tapes had limited visibility and poor durability under many road conditions. Improved tapes permitted long-term or temporary application and provided skid resistance, low-temperature durability, high-temperature durability and reflectivity. Commercial examples include 3M™ Stamark™ and 3M™ Series 145 tapes.

Despite advances in pavement-marking tapes, motorists and pedestrians have been provided with minimal information at best. Sidewalk and crosswalk delineation, centerlines and other road markings are beneficial, but additional information may be useful to both motorists and pedestrians, including information of a commercial nature. There is a need for an efficient, effective, and safe means to provide motorists and pedestrians with more information than past pavement-based communications media have been able to provide.

### SUMMARY

The claims at the close of this specification set forth a full and accurate description of applicant's successful solution to the problems discussed above. To the extent consist with those claims, applicant states that he has developed at least the following:

First, a pavement tape for conveying information when affixed to pavement, said pavement tape comprising an elongated flexible tape body comprising front and rear faces, said front face comprising at least one symbol that conveys information.

Second, a pavement tape for conveying commercial information when affixed to pavement, said pavement tape comprising an elongated flexible tape body comprising front and rear faces, said front face bearing at least one symbol that conveys commercial information and said rear face comprising an adhesive for bonding said pavement tape to pavement.

Third, a pavement tape for conveying commercial information when affixed to pavement, said pavement tape comprising symbol means for conveying commercial information, and body means for supporting said symbol means on pavement.

Fourth, a method of conveying information from pavement comprising the steps of creating a flexible pavement tape having a front and rear faces, said front face comprising at least one symbol conveying information, locating a section of pavement for installing said pavement tape, and bonding said rear face of said pavement tape to said pavement section.

### DESCRIPTION OF THE DRAWINGS

FIG. 1 depicts a top view of a section of a continuous pavement tape.

FIG. 2 depicts a perspective view of the pavement tape of FIG. 1.

FIG. 3 depicts a top view of a section of another continuous pavement tape.

FIG. 3A depicts a top view of a section of another continuous pavement tape.

FIG. 4 depicts a top view of the pavement tape of FIG. 1 coated with reflective glass beads.

FIG. 5 depicts an end view of the pavement tape of FIG. 4.

FIG. 6 depicts an end view of the pavement tape of FIG. 1 bonded to a protective tape.

FIG. 7 depicts a process of bonding to pavement the composite tape structure of FIG. 6.

FIG. 8 depicts completion of the bonding process of FIG. 7.

FIG. 9 depicts removal of the protective tape from the bonded composite tape structure of FIG. 8.

FIG. 10 depicts the composite tape structure of FIG. 6 with an additional adhesive layer.

FIG. 11 depicts the composite tape structure of FIG. 10 bonded to pavement.

FIG. 12 depicts the composite tape structure of FIG. 10 with a release tape.

FIG. 13 depicts removal of the release tape from the composite tape structure of FIG. 12.

FIG. 13A depicts a section of a standard pedestrian crosswalk.

FIG. 13B depicts a detail of the pedestrian crosswalk of FIG. 13A with pavement tapes bearing commercial information.

FIG. 13C depicts a section of pavement in a parking lot with pavement tapes bearing commercial and other information.

FIG. 13D depicts a mid-section of pavement marking tape with protective railings.

FIG. 14 depicts a top view of a section of a continuous perforated pavement tape.

FIG. 15 depicts an end view of the tape section of FIG. 14.

FIG. 16 depicts a perspective view of the tape section of FIG. 14.

FIG. 17 depicts the bonding of a composite tape structure of the continuous perforated pavement tape of FIG. 14 to a pavement pre-bonded to reflective glass beads.

FIG. 18 depicts a mask tape with a single mask perforation.

FIG. 19 depicts a perforated pavement tape with a single symbol perforation.

FIG. 20 depicts a placement of the FIG. 18 mask tape over the FIG. 19 perforated pavement tape.

FIG. 21 depicts the bonding of a composite form of the mask tape of FIG. 18 to a pre-applied perforated pavement tape of FIG. 19.

FIG. 22 depicts a composite form of the perforated pavement tape of FIG. 17 with a protective coating.

FIG. 23 depicts a top view of the perforated pavement tape of FIG. 19 with a chamfered edge.

FIG. 24 depicts a sectional side view of the perforated pavement tape of FIG. 23.

### DETAILED DESCRIPTION OF THE DRAWINGS

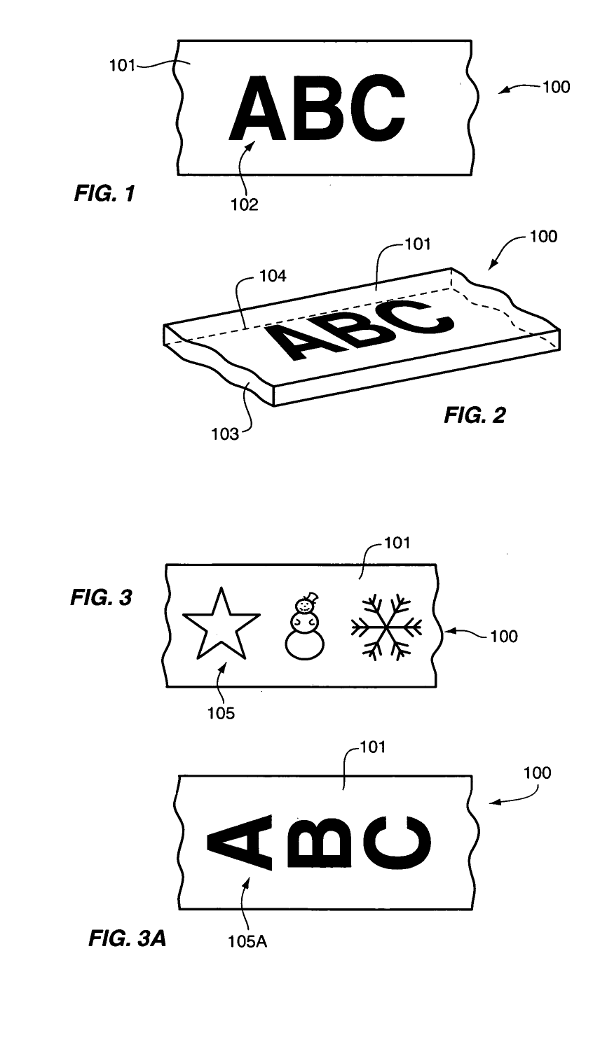

FIG. 1 depicts a top view of a section of a continuous pavement tape 100. This tape comprises a tape body 101 and a series of symbols 102 arrayed on the surface of the tape body. Here the symbols 102 define the first three letters of the English alphabet.

Tape body 101 is made from plastic based on an acrylic resin, but it may be made from many other forms and types of material. For example, tape body 101 may be made from sheet or bar stock. Useful materials include other plastics, fabrics and woven metal screens, aluminum being one useful metal for that purpose.

An alternative to tape body 101 could be a paint made of or from a paint of the many types used to paint pavement. The color, thickness and other characteristics of the paint are a matter of design choice depending upon the application. Some characteristics may include optical effects, such as view-angle determinant color-shifting, temperature-determinant color-shifting, fluorescing, or glow-in-the-dark paint or paint components. If suggested by the application, reflective beads may be included in the paint formulation. As another alternative, tape body 101 is made of biodegradable materials providing self-removing and/or environment-friendly pavement tape 100.

As shown in FIG. 1, tape body 101 has parallel sides. There is no requirement for this. Depending upon the application, tape body 101 may have non-parallel sides, matching or unmatched curved sides, and configurations having one straight side and one curved side.

FIG. 2 depicts a perspective view of the pavement tape of FIG. 1. Tape body 101 is relatively thick. There is no requirement for this particular thickness. The thickness of tape body 101 is a matter of design choice depending on the application.

Symbols 102 may be any known symbols. The symbols may be the letters of a language. English language symbols would be probable symbols of choice for a pavement tape 100 intended for use in an English-speaking country. Arabic language symbols would be appropriate for an Arabic-speaking country.

Signs based on the letters of a language could serve a variety of purposes. They could convey traffic conditions, road conditions, detour requirements, turn requirements, the presence of pedestrians, the delineation of parking areas for the disabled and the like. In other contexts, the symbols could be advertisements by local, national, or international purveyors of goods or services, solicitations by community agencies or charitable institutions, directions to community landmarks, safety reminders, such as “know when to say when,” and the like. These symbols would attract the attention of both motorists and pedestrians, particularly where they were from out of town.

As illustrated by FIG. 3, the symbols of pavement tape 100 also may be non-language symbols. FIG. 3 depicts a top view of a section of another continuous pavement tape. The symbols 105 of this pavement tape are fanciful, comprising a star, a snowman and a snowflake. The symbols also could relate to motorist activity or safety. Thus, the symbols could be turn arrows, stop indicators, road condition indicators, detour indicators, disabled indicators and the like. Beyond this, the symbols could be pictures of hotels, motels, eating establishments, gasoline stations and other services of interest to motorists and pedestrians. These symbols could be combined with language-based symbols to form a composite message for the motorist or pedestrian.

The symbols 102 of pavement tape 100 are approximately half the width of tape body 101. This is not a requirement, but rather is application dependent. At one extreme, the symbols may be close to the entire width of the tape. At the other extreme, the symbols may be as small as permitted by the application. For example, smaller symbols may be required where symbols are stacked on top of one another across the width of the tape. There is no requirement that all symbols be the same height. Depending upon the application, the symbols may have different heights.

Symbols 102 may be differentiated from tape body 101 in many ways. They may be painted or printed onto tape body 101 in a color or colors contrasting with the color or colors of tape body 101. They may be etched or embossed into the surface of tape body 101. They may be engraved into the surface of tape body 101. They may be cut entirely through tape body 101, as will be discussed in detail later. The application dictates the manner in which symbols 102 are differentiated from tape body 101.

As illustrated by FIG. 3A, there is no requirement that a symbol be oriented so that its vertical axis is perpendicular to some part or parts of one or both edges of tape body 101. FIG. 3A depicts a top view of a section of another continuous pavement tape. This pavement tape bears symbols 105A, which comprise three letters of the English alphabet. In contrast to the pavement tape of FIG. 1, these symbols are oriented so that their respective vertical axes are parallel to the edges of tape body 101. Depending on the application, a symbol may have a broad range of angular orientations relative to one or both edges of tape body 101.

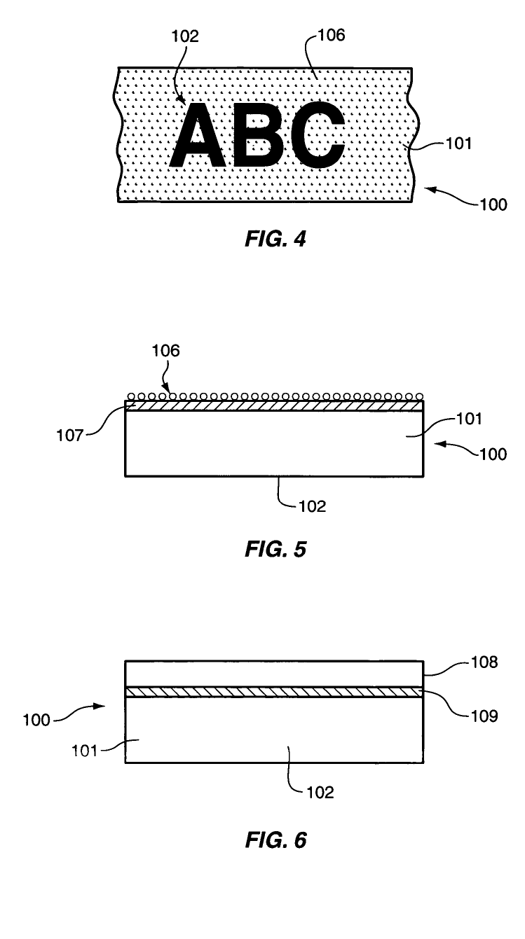

FIG. 4 depicts a top view of the pavement tape of FIG. 1 coated with reflective glass beads. These beads are widely used for road signs and pavement markings. When automobile lights project upon reflective glass beads, the light is gathered and reflected back to the motorist. This makes it easy to see the beads. Reflective glass beads often are arranged in the form of letters and other symbols to convey traffic information and the like to motorists, and to pedestrians as well.

Glass beads are useful in pavement tape 100. In FIG. 4, reflective glass beads 106 have been arranged over the entire front surface of tape body 101, except that symbols 102 have not been obscured. A motorist viewing the pavement tape of FIG. 4 in automobile headlights at night would observe a field of light surrounding symbols 102, which would appear dark by contrast.

Reflective glass beads are not required in the pavement tape of FIG. 4. Any material that contrasts with symbols 102 will accomplish the same or a comparable result, although perhaps not as emphatically at night. In the day, however, reflective glass beads have no particular contrast advantage and may exhibit poorer performance than other surfaces. Bright paints and plastics impregnated with bright pigments are often superior to reflective glass beads in this context. Thus, for daytime use or for other uses dictated by the application, tape body 101 might usefully be coated on its top surface with a bright paint or plastic rather than reflective glass beads 106, or simply be formed of an appropriately bright material. On the other hand, symbols 102 may be formed of glass beads or other bright material, and tape body 101 left relatively dark.

There is no requirement that reflective glass beads 106 or comparable materials be placed over the entire front surface of tape body 101. Reflective glass beads 106 may be placed over a smaller area of tape body 101 if the application so dictates. Other materials may be used in areas where reflective glass beads 106 are not present. For example, a bright paint might be used to create a pavement tape that is useful in both day and night, or a different type of reflective glass beads might be used to enhance night performance. Similarly, an abrasive might be used to enhance traction for pedestrians as well as motorists.

FIG. 5 depicts an end view of the pavement tape of FIG. 4. Reflective glass beads 106 are held in place by reflective glass bead adhesive 107. This layer of reflective glass bead adhesive 107 is securely fastened to both tape body 101 and reflective glass beads 106. A number of techniques have been developed in the art for attaching reflective glass beads to a substrate. These will not be detailed here.

FIG. 6 depicts an end view of the pavement tape of FIG. 1 bonded to a protective tape. In particular, protective tape 108 is bonded to the pavement tape of FIG. 1 by adhesive 109. Protective tape 108 may be made from any common tape material. Protective tape adhesive 109 is a low-tack PSA adhesive that bonds weakly to tape body 101 but more strongly to protective tape 108, allowing protective tape 108 to be easily removed from the surface of tape body 101, taking protective tape adhesive 109 with it. This leaves a clean top surface of tape body 101. Any one of a number of other adhesives may serve effectively as protective tape adhesive 109. In some applications, protective tape adhesive 109 may be done away with altogether and the necessary release properties incorporated into the surface of protective tape 108.

Protective tape 108 serves to protect the top surface of tape body 101 from abrasion, denting, burning and injury of other kinds before the pavement tape 101 is installed on pavement 110. Protective tape 108 also prevents injury during installation. Beyond that, it serves to keep tape body 101 flat and aligned during storage and installation.

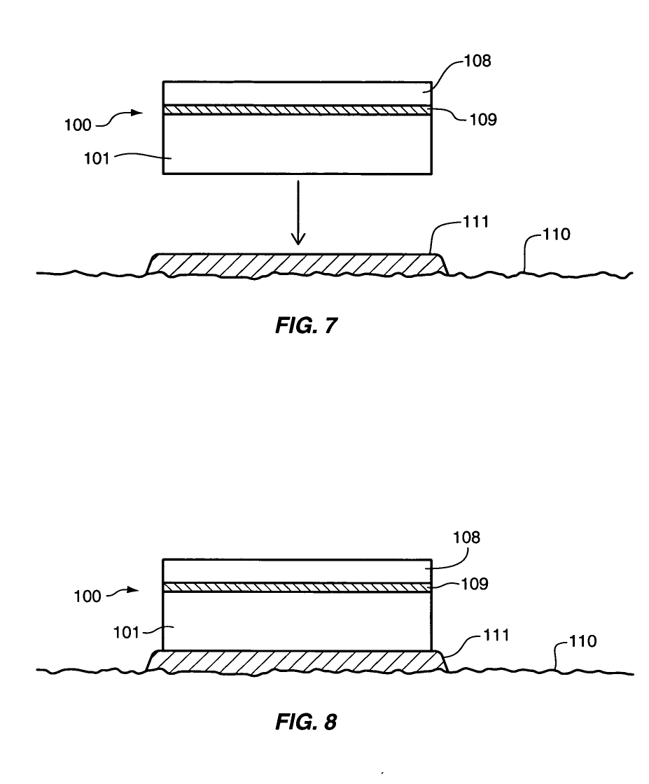

FIG. 7 depicts a process of bonding the composite tape structure of FIG. 6 to pavement 110. Pavement 110 may comprise any one of a wide variety of pavement materials available presently and the past. These include bricks, concrete-based compositions, tar-based compositions and rubber-based compositions.

In FIG. 7, the composite tape structure of FIG. 6 is being lowered onto a bed of pavement adhesive 111. This pavement adhesive 111 may be any one of a number of types of adhesive. Generally speaking, it will be high tack with a high cure strength and low creep, although these and other characteristics will vary with the application.

The composite tape structure of FIG. 6 is positioned over pavement adhesive 111 on pavement 110 and the exact placement of the composite tape structure is determined and achieved. The composite tape structure is then lowered so that the bottom of tape body 101 contacts pavement adhesive 111.

FIG. 8 depicts the completion of the installation process of FIG. 7. Downward pressure is applied to protective tape 108 until the bond between the FIG. 6 composite tape structure and pavement 110 has met the specifications of the particular application. The amount and duration of bonding pressure are functions, among other things, of the type of adhesive used, the composition of tape body 101, the composition and surface condition of pavement 110, and the ambient conditions at the time of application.

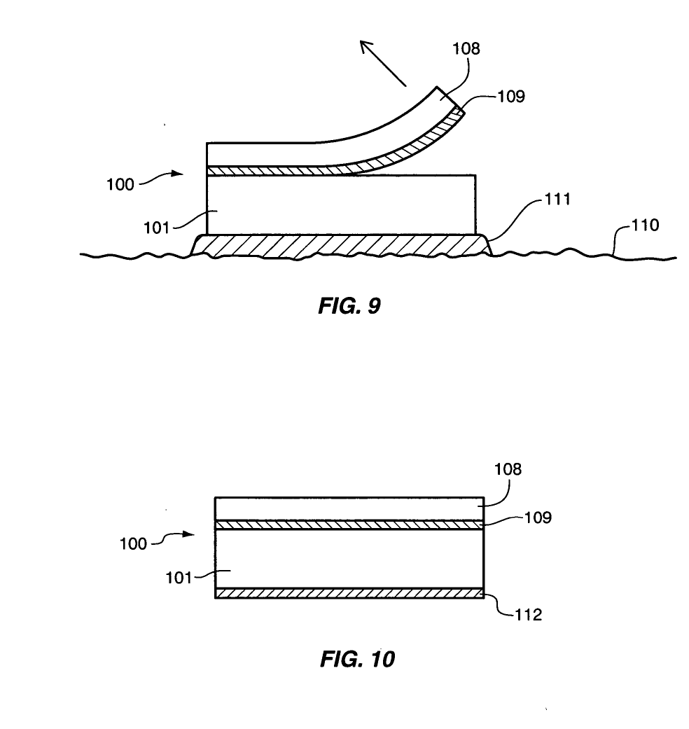

FIG. 9 depicts removal of protective tape 108, with protective tape adhesive 109, from the surface of tape body 101. Protective tape 108, with protective tape adhesive 109, is lifted from one exposed edge of tape body 101 and peeled from the surface of tape body 101, leaving it clean and ready for use. Protective tape 108 may be reused, recycled or discarded.

FIG. 10 depicts the composite tape structure of FIG. 6 with a layer of pavement tape adhesive 112 on the bottom of tape body 101. The purpose of the layer of pavement tape adhesive 112 is to bond the composite tape structure of FIG. 6 to pavement 110. Pavement tape adhesive 112 may be an adhesive of the type described in connection with the discussion of FIG. 7, but also may be one of a variety of other types of adhesives.

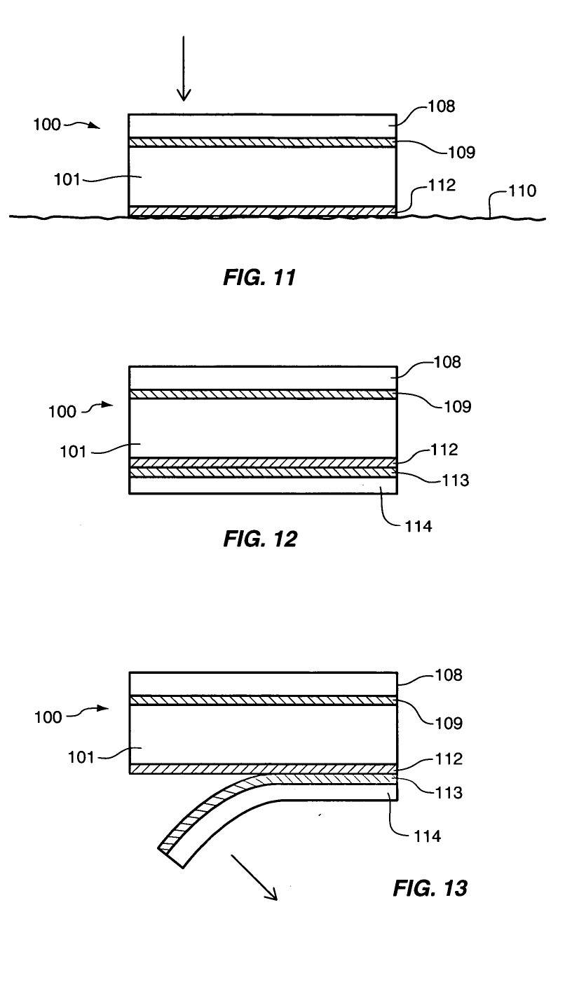

FIG. 11 depicts the composite tape structure of FIG. 10 bonded to pavement 110. The composite tape structure of FIG. 10 was positioned over pavement 110 and the exact placement of the tape structure was determined and achieved. The FIG. 10 tape structure was then lowered to pavement 110 so that pavement tape adhesive 112 contacted pavement 110. Pressure was then applied to protective tape 108 until the bond between the FIG. 10 composite tape structure and pavement 110 met the specifications dictated by the application. The amount and duration of pressure on the FIG. 10 tape structure are functions, among other things, of the type of adhesive used, the composition of tape body 101, the composition and surface condition of pavement 110, and the ambient conditions at the time of application.

FIG. 12 depicts the composite tape structure of FIG. 10 with a release layer 113 and release tape 114. The layer of pavement tape adhesive 112 at the bottom of the composite tape structure of FIG. 10 is susceptible to abrasion, denting, burning and injury of other kinds. Dirt or dust alone can ruin or at least impair the effectiveness of pavement tape adhesive 112.

Release tape 114 and release layer 113 protect the surface of pavement tape adhesive 112. Release layer 113 is a low-tack PSA adhesive that bonds weakly to pavement tape adhesive 112 but provides a stronger bond to release tape 114. Any one of a number of other adhesives may serve effectively as release layer 113. In some applications, release layer 113 may be done away with altogether and the necessary release properties incorporated into the surface of release tape 114.

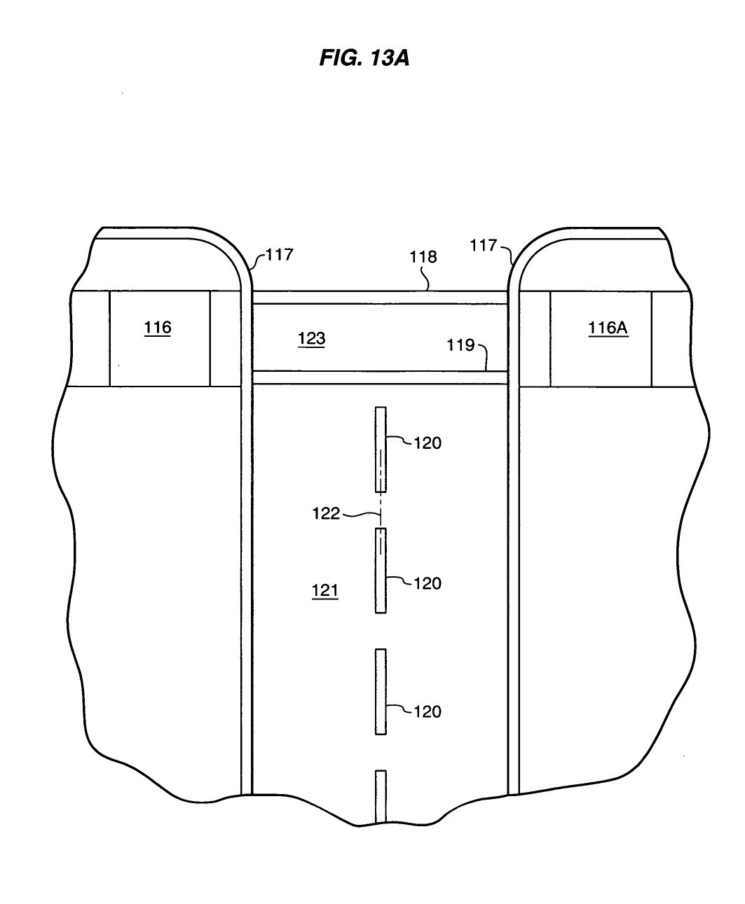

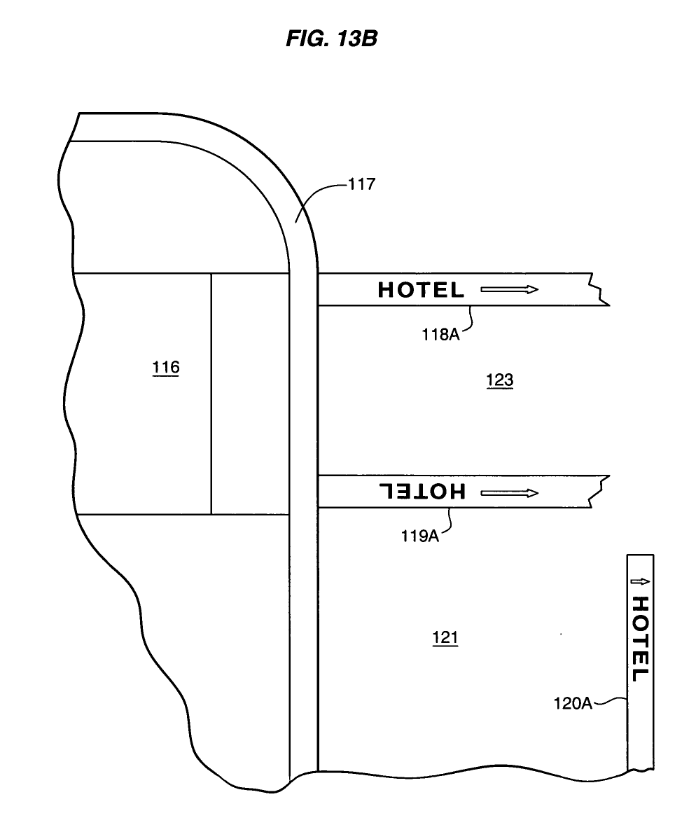

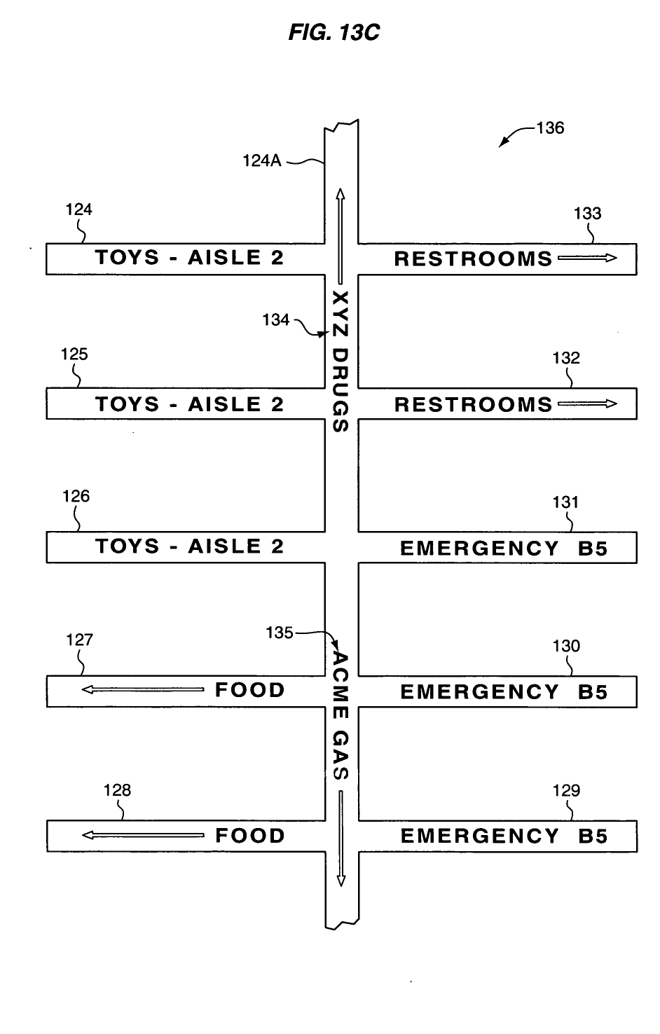

FIG. 13 depicts removal of release layer 113 and release tape 114 from the composite tape structure of FIG. 12. At the time of bonding, release tape 114 and release layer 113 are peeled from pavement tape adhesive 112, exposing it for bonding to pavement 110. Removal of release tape 114 and release layer 113 may be delayed until the composite tape structure of FIG. 12 is at its desired location over pavement 110. This avoids the difficulties that can result from attempting to place a tape coated with a strong, active adhesive. These difficulties include misplacements, wrinkled placements or incorporation of dirt into the adhesive surface, diminishing or ruining its effectiveness.

FIG. 13A depicts a section of a standard pedestrian crosswalk approximately 30 feet wide. Pavement 121 is bounded by curbs 117. Centerline 122 is defined by centerline markers 120. Pedestrian crosswalk 123 is defined by first crosswalk band 118 and second crosswalk band 119. Sidewalks 116 and 116A terminate at the ends of pedestrian crosswalk 123. All pavement markers are painted in white.

FIG. 13B depicts a detail of the pedestrian crosswalk of FIG. 13A. The painted pavement markers 118, 119 and 120 have been replaced with pavement tapes 118A, 119A and 120A, each of which bears commercial information. In particular, each of the tapes directs the onlooker to a hotel The tapes are white with black lettering, are about 6 to about 12 inches wide and are bonded to pavement 121.

The lettering on first crosswalk tape 118A has been oriented to face a pedestrian passing through the crosswalk 123 in either direction. The same is true of the lettering on crosswalk tape 119A. The lettering on centerline tape 120A has been oriented so that it is upright to a pedestrian passing from sidewalk 116 through the crosswalk 123, but inverted to a pedestrian passing through the crosswalk in the opposite direction. Were the lettering on centerline tape 120A oriented so that it is inverted to a pedestrian passing from sidewalk 116 through the crosswalk 123, it would appear upright to a motorist stopped at crosswalk 123.

FIG. 13C depicts a section of pavement in a parking lot 136 with pavement tapes delineating parking spaces and bearing commercial and other information. Parking lot 136 may be an indoor parking structure or pedestrian walkway with limited lighting. Commercial information appears on parking tape segments 124, 125, 126, 127, 128 and on centerline tape 124A. Parking tape segments 124, 125 and 126 refer generically to“TOYS” without identifying a source but rather identifying“AISLE 2” as a location for the toys. This information appears upright to a motorist parking in one of the two spaces but inverted to someone riding in the passenger seat. The lettering of the information may be reversed so that it is inverted to the motorist but upright to the passenger.

Parking tape segments 127 and 128 refer generically to“FOOD” and, with an arrow, specify a general direction in which the food may be found. An example might be a collection of fast-food establishments. The letters might be inverted as discussed above. Parking tapes 129 through 133 relate to services. Tapes 132 and 133 use an arrow to point out the general direction of“RESTROOMS”, while tapes 129 though 131 identify the location of“EMERGENCY” services at a specific location“B5”, which could for example be a floor and sector identifier. Here again, the letters might be inverted as discussed above.

Centerline tape 124A sets forth commercial information for the general direction, by opposite arrows, of“XYZ DRUG” and“ACME GAS”. These messages are upright to a motorist and passenger parking on the left side of centerline tape 124A but inverted to a motorist and passenger parking on the right side. The letters may be inverted to reverse the situation, or only one message may be inverted so that left-side motorists and passengers see, for example,“XYZ DRUG” upright and“ACME GAS” inverted. Right hand motorists, of course, would see the opposite.

The tapes of FIG. 13C may be of any size and shape consistent the needs of a parking lot. The thicknesses and colors of the tapes and letters are limited only by the dictates of the application. Glass beads and other reflective materials may be used, again depending on the dictates of the application.

FIG. 13D depicts a mid-sectional view in perspective of pavement tape 100 with railings 140A, 140B. Railings 140A, 140B provide a protective recess for pavement tape 100 from weather or traffic damage. The height of railings 140A, 140B may be greater, less than, or the same as tape 100 as a matter of design choice depending on the application.

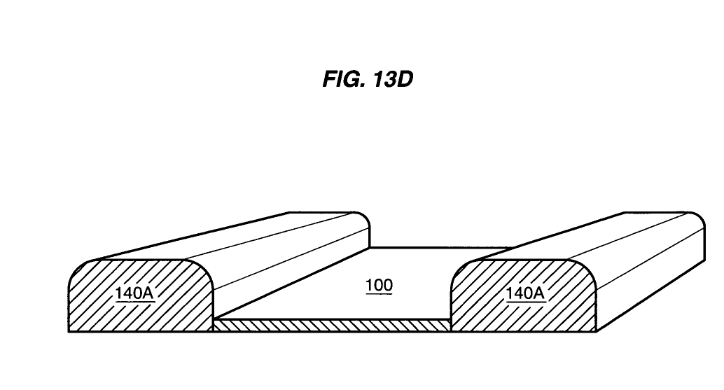

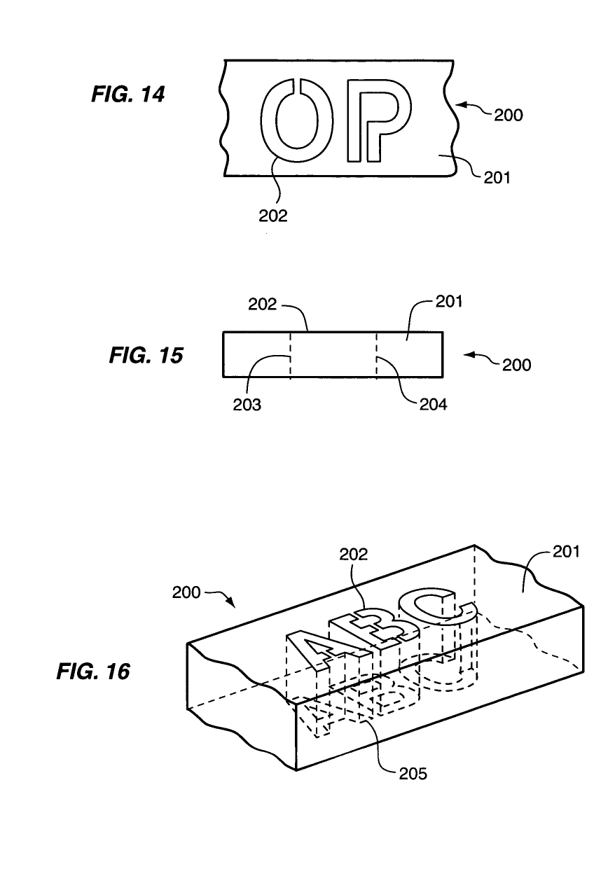

FIG. 14 depicts a top view of a section of a continuous perforated pavement tape 200. This tape comprises a tape body 201 and a series of symbol perforations 202 through the tape body. The symbol perforations 202 define a series of symbols. In particular, the perforations define the letters“O” and“P” of the English alphabet.

FIG. 15 depicts an end view of the perforated pavement tape of FIG. 14. Dotted line 203 represents the top boundary of symbol perforations 202 and dotted line 204 represents the bottom boundary of symbol perforations 202. Tape body 201 is relatively thick. As noted previously, there is no requirement for any particular thickness. The thickness of tape body 201 is a matter of design choice depending on the application.

FIG. 16 depicts a perspective view of a perforated pavement tape with symbol perforations 202 comprising the first three letters of the English language. This view shows the projection of symbol perforations 202 through the entirety of tape body 201. Dotted lines 205 represent symbol perforations 202 where they terminate in reverse projection on the back of tape body 201. Thus, symbol perforations 202 represent a series of perforations through tape body 201. It is not necessary that the perforations extend all the way through tape body 201, particularly where tape body 201 is made of a clear material. Nor is it necessary that symbol perforations 202 have the same size at the front and back of tape body 201.

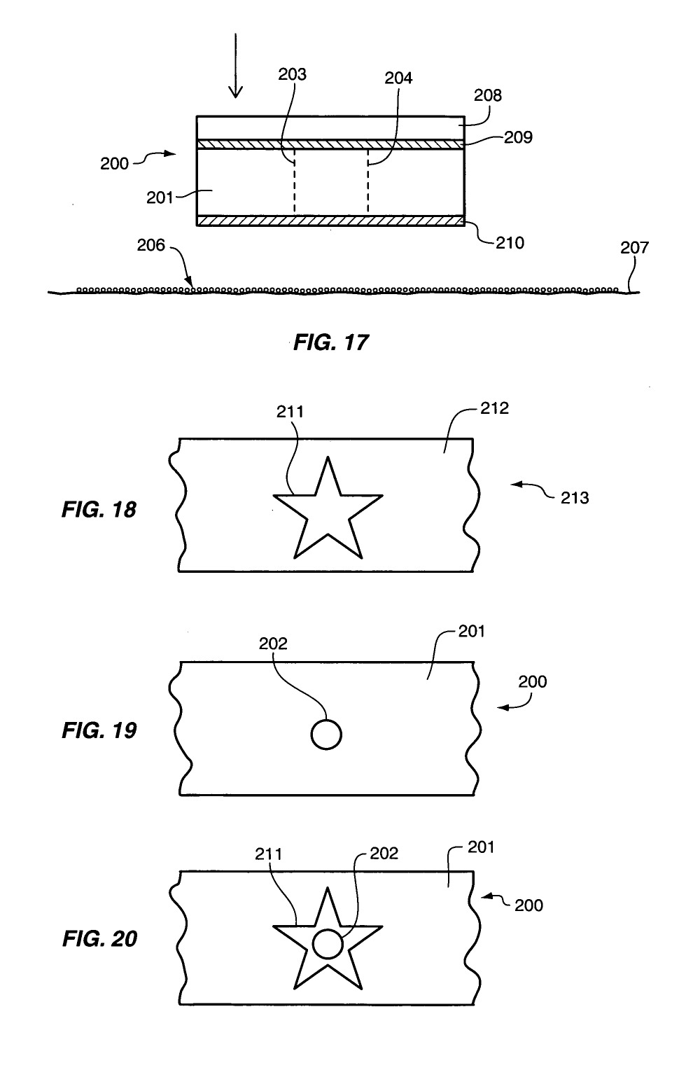

FIG. 17 depicts the application of a composite tape structure like that of FIG. 13 but constructed using a perforated pavement tape as discussed in connection with FIGS. 14-16. The composite tape structure is being bonded to pavement 207, which itself has been pre-bonded to reflective glass beads 206. More particularly, the structure is being lowered for bonding to the layer of reflective glass beads 206 and subsequent removal of protective tape 208 and protective tape adhesive 209. A motorist viewing the perforated pavement tape of FIG. 17 at night in automobile headlights (or a pedestrian with a flashlight) would observe a field of darkness surrounding symbol perforations 202, which would appear brightly lit by the underlying reflective glass beads, the opposite of the effect created by the pavement tape of FIGS. 4 and 5.

FIG. 18 depicts a mask tape 213 comprising a mask tape body 212 and a single star-shaped mask perforation 211. The mask perforation need not be a symbol. FIG. 19 depicts a perforated pavement tape 200 comprising a tape body 201 and a single circular symbol perforation 202. FIG. 20 depicts the result obtained when mask tape 213 is positioned over perforated pavement tape 200. The only part of tape body 201 that is visible through mask perforation 211 is that part of tape body 201 that bears the circular symbol perforation 202. If mask tape body 212 is black, and if tape body 201 is embedded on its top surface with reflective glass beads backed with black pavement, the visual result at night to a motorist using headlights or a pedestrian with a flashlight will be a shining star with a black center.

Composite images of this type may take many forms. They may be built from two layers of tape or from many layers. The component tapes may be any of a spectrum of colors and textures, including transparent components. Transparent components may provide actual visual depth and provide a viewer with a three-dimensional image. Holographic or other components may simulate visual depth and provide a viewer with an illusion of a three-dimensional image. Upper perforations need not surround lower perforations in their entirety, but rather surround only portions of lower perforations. Designer choices govern these selections.

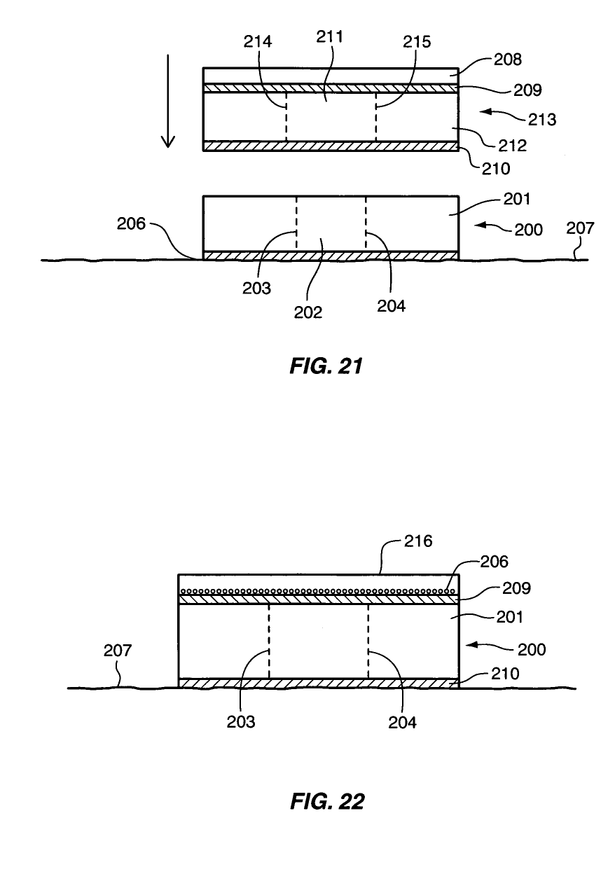

FIG. 21 depicts the creation of a two-color composite perforated pavement tape using the mask tape of FIG. 18 and the pavement perforation tape of FIG. 19. Here tape body 201 is colored red and is bonded to pavement 207, which is black. Circular symbol perforation 202 has boundaries 203 and 204.

Mask tape 213 has a green mask tape body 212. The top surface of the body is bonded to protective tape 208 by protective tape adhesive 209. Its bottom surface is coated with an adhesive of the same type used to bond perforated pavement tape 200 to pavement 207, although this is not a requirement. Mask tape 213 is perforated by mask perforation 211 with boundaries 214 and 215, which exceed boundaries 203 and 204 of perforated pavement tape 200 at all points, as depicted in FIG. 20.

When mask tape 213 is bonded to perforated pavement tape 200 so that mask perforation 211 is aligned directly above symbol perforation 202, as illustrated in FIG. 20, a viewer will observe the green surface of mask tape body 212 interrupted by the star-shaped mask perforation 211. Behind mask perforation 211, the viewer will observe the smaller, circular symbol perforation 202 of perforated pavement tape 200. That symbol will be as black as the pavement beneath it and surrounded by the red of tape body 201 up to the boundaries imposed by mask perforation 211 of mask tape body 212. The visual result will be a red star with a black center in a green backdrop.

FIG. 22 depicts the composite tape of FIG. 11 with a layer of reflective glass beads 206. This layer of reflective glass beads is covered with protective coating 216. A protective coating is often useful for protecting the perforated pavement tapes and composite structures discussed above, whether or not they are covered with reflective glass beads.

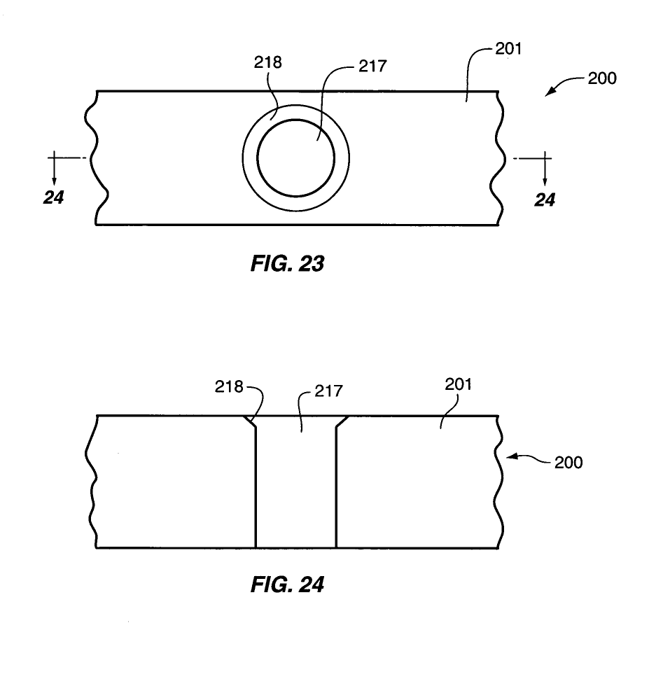

FIG. 23 depicts a perforated pavement tape 200 comprising a tape body 201 and a symbol perforation 217. The symbol perforation 217 is circular and its upper edge 218 has been chamfered. FIG. 24 depicts a section of the perforated pavement tape of FIG. 23. Chamfering may in some circumstances serve to preserve the life of perforated pavement tape 200 by avoiding sudden or catastrophic failure of symbol perforation edges. This is a design choice, however, not a requirement.

The detailed description of the drawings set forth above and the various tape and pavement configurations described in that detailed description do not, cannot, and are not intended to limit the scope of this application or any patent that issues from this application. The sole measure of the scope of this application is the claims that follow.

1. A pavement tape for conveying information when affixed to pavement, said pavement tape comprising an elongated flexible tape body comprising front and rear faces, said front face comprising at least one symbol that conveys information.

2. The pavement tape of claim 1 wherein said rear face comprises an adhesive for bonding said pavement tape to pavement.

3. The pavement tape of claim 2 further comprising a flexible release tape, one face of which is releasably bonded to said adhesive.

4. The pavement tape of claim 1 further comprising a flexible protective tape, one face of which is releasably bonded to said front face of said pavement tape.

5. The pavement tape of claim 1 wherein said at least one symbol conveys commercial information.

6. The pavement tape of claim 1 wherein said tape is from about 6 to about 12 inches in width.

7. The pavement tape of claim 1 wherein at least part of said at least one symbol is reflective.

8. The pavement tape of claim 1 wherein at least part of said front face is reflective.

9. The pavement tape of claim 1 wherein said at least one symbol is formed as a perforation extending at least partly from said front face to said rear face of said tape body.

10. The pavement tape of claim 1 further comprising a mask tape, said mask tape comprising a flexible mask tape body having front and rear mask faces and at least one symbol formed as a perforation extending from said front mask face to said rear mask face, said rear mask face of said mask tape being bonded to said front face of said pavement tape.

11. The pavement tape of claim 1 further comprising at least one railing attached to the pavement and protecting at least one edge of said pavement tape.

12. A pavement tape for conveying commercial information when affixed to pavement, said pavement tape comprising an elongated flexible tape body comprising front and rear faces, said front face bearing at least one symbol that conveys commercial information and said rear face comprising an adhesive for bonding said pavement tape to pavement.

13. The pavement tape of claim 12 further comprising a flexible protective tape, one face of which is releasably bonded to said front face of said pavement tape.

14. The pavement tape of claim 13 further comprising a flexible release tape, one face of which is releasably bonded to said adhesive.

15. The pavement tape of claim 14 wherein said tape is from about 6 to about 12 inches in width.

16. The pavement tape of claim 13 wherein at least part of said at least one symbol is reflective.

17. The pavement tape of claim 13 wherein at least part of said front face is reflective.

18. The pavement tape of claim 13 wherein said at least one symbol is formed as a perforation extending at least partly from said front face to said rear face of said tape body.

19. The pavement tape of claim 11 further comprising at least one railing attached to the pavement and protecting at least one edge of said pavement tape.

20. A pavement tape for conveying commercial information when affixed to pavement, said pavement tape comprising
symbol means for conveying commercial information; and
body means for supporting said symbol means on pavement.

21. A pavement tape of claim 20 wherein said body means includes a railing for protecting an edge of said pavement tape.

22. A method of conveying information from pavement comprising the following steps:
creating a flexible pavement tape having a front and rear faces, said front face comprising at least one symbol conveying information;
locating a section of pavement for installing said pavement tape; and
bonding said rear face of said pavement tape to said pavement section.

23. A pavement paint for conveying information when applied to pavement, said pavement paint comprising an elongated paint layer comprising at least one symbol that conveys information.

24. The pavement tape of claim 23 wherein said at least one symbol conveys commercial information.

25. The pavement paint of claim 23 wherein said tape is from about 6 to about 12 inches in width.

26. The pavement paint of claim 23 wherein at least part of said at least one layer is reflective.

27. The pavement paint of claim 23 wherein at least part of said layer is reflective.
